(19) United States
(12) Patent Application Publication
(10) Pub. No.: US 2002/0198049 A1
(43) Pub. Date: Dec. 26, 2002

(54) Electronic game playing apparatus

(75) Inventors: Khai Pang Tan, Singapore (SG); Ekanayake Mudiyanselase Lalshman Ekanayake, Singapore (SG); Nuntha Kumar S/O Krishnasamy Maniam, Singapore (SG); Ah Guan Lee, Singapore (SG); Guimei Dai, Singapore (SG); Marc Howard Popek, Las Vegas, NV (US)

Correspondence Address: GREENBLUM & BERNSTEIN, P.L.C., 1941 ROLAND CLARKE PLACE, RESTON, VA, 20191, US

(73) Assignee: ADDVALUE TECHNOLOGIES Ltd. of SINGAPORE

(21) Appl. No.: 09/887,423

(22) Filed: Jun. 25, 2001

(51) Int. Cl. A63F 13/00

(52) U.S. Cl. 463/39

(57) ABSTRACT

Game playing apparatus is disclosed comprising a game controller arranged to be held by a game player and a base station connected to or forming part of a game console, the controller and base station communicating over a wireless link and wherein the base station is provided with a loop aerial and the game controller is provided with either a dipole aerial or a loop aerial.

### BACKGROUND AND FIELD OF THE INVENTION

This invention relates to electronic game playing apparatus, more particularly to wireless game controllers and game consoles.

In the game accessories industry for products such as the Sony PS-1, PS-2, or Nintendo game consoles, the majority of game pads or controllers available today are wired to the game consoles, A wireless implementation has been proposed in which the wire between the game controller and the game console is removed. Respective radio frequency transceivers' are provided in the wireless game controller and the game console, with the wireless communication operating in the unlicensed 900 MHz ISM band. It is a disadvantage of existing wireless proposals that the performance is not yet comparable with that of the wired version.

It is an object of the invention to provide game playing apparatus which alleviates this problem to some degree and/or provides the general public with a useful choice.

### SUMMARY OF THE INVENTION

According to the invention in a first aspect there is provided a wireless electronic game controller operable by a game player and arranged to communicate with a game console over a wireless link via an aerial and wherein the aerial is a loop aerial or a dipole aerial.

According to the invention in a second aspect, there is provided a wireless electronic game base station connected to or forming part of a game console and arranged to communicate with the game controller over a wireless link via an aerial and wherein the aerial is a loop aerial.

According to the invention in a third aspect, there is provided a game playing apparatus comprising a game controller arranged to be held by a game player and a base station connected to or forming part of a game console, the controller and base station communicating over wireless link and wherein the base station is provided with a loop aerial and the game controller is provided with either a dipole aerial or a loop aerial.

The invention arose as a result of the inventors' investigations of how performance of a wireless game apparatus may be improved. The inventors realised as a major contributing factor was the inefficiency of the aerials used in current wireless game controllers and base stations which are monopole in design and tend to have poor directionality and, in the case of the game controller, suffer from human body effects which provide inconsistent results.

In the embodiment of the present invention, a dipole aerial is selected for the controller due to reception/transmission directionality properties which minimise interference of other unrelated sources and reduced human body effects to provide more consistent and predictable results leading to better yield in manufacturing. In addition, the dipole aerial provides higher gain bandwidth and good radiation efficiency which reduces transmission power and hence prolongs battery life. For the base station, a rectangular loop aerial is used due to good directionality and high gain.

### BRIEF DESCRIPTION OF THE DRAWINGS

An embodiment of the invention will now be described, by way of example, with reference to accompanying drawings in which.

FIG. 1 is a three-dimensional view of one half of a dipole aerial included in a same controller being a first embodiment of the invention;

FIG. 2 is a three-dimensional view showing the dipole aerial connected to a PCB of the game controller;

FIG. 3 is a three-dimensional view of the game controller showing circuitry in place upon the PCB on which the dipole aerial is mounted;

FIG. 4 illustrates a loop aerial included in a base station being a second embodiment of the invention;

FIG. 5 shows a three-dimensional view of a base station PCB showing the loop aerial of FIG. 4 attached thereto;

FIG. 6 shows the aerial driving circuitry of the controller of FIGS. 1-3; and

FIG. 7 shows the driving circuitry of a loop aerial of FIGS. 4 and 5 of a base station.

### DETAILED DESCRIPTION OF THE PREFERRED EMBODIMENT

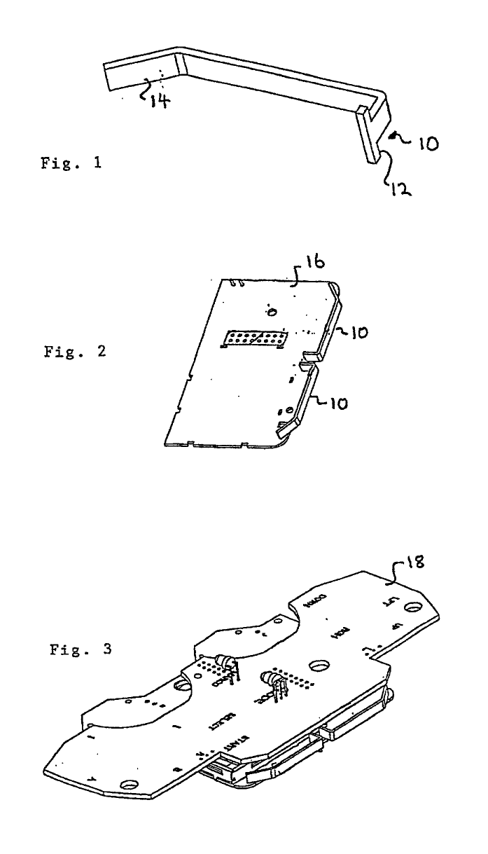

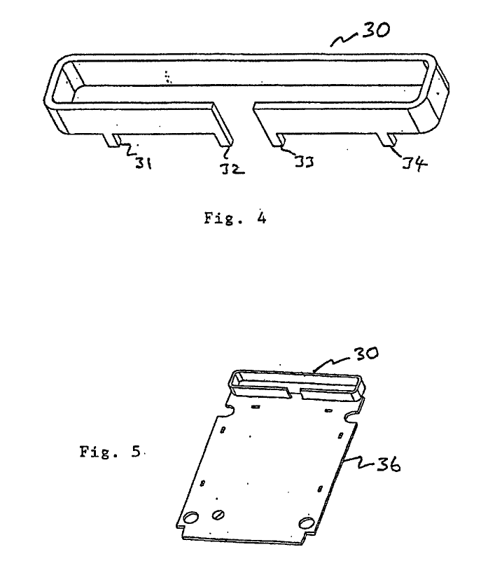

An aerial included in a game controller of a first embodiment of the invention, is is shown in FIGS. 1-3. The aerial is a dipole aerial formed from two mirror image pieces of bent metal of which one is shown in FIG. 1 which comprises a head 10 having a lug 12 and a tail 14. As shown in FIG. 2, the two mirror image halves of the dipole 10 are connected to a printed circuit board 16 upon which the circuitry 18 of the game controller is mounted. The lugs 12 of each dipole half engage corresponding openings in the circuit board to hole the aerial halves in place and provide electrical connections to driver circuitry. The aerial halves are mounted along a peripheral side of the game controller which, in use, would face away from the body of the game player and are arranged to fit within a plastic casing of the game controller which encases the aerial 10, PCB 16 and circuitry 18. The aerial is used to communicate wirelessly with a base station (described below) on the 900 MHz ISM band from 902 MHz to 929 MHz. A duplex implementation used 902.2 MHz-904.4 MHz for one way and 924.8 MHz and 927.5 MHz for the other way.

For the dipole to be tuned to the transmission/reception frequencies, it is preferable for this to be at a one half wave length, L=144/F(MHz)m, with the length L being defined as the physical length which is 5% shorter than the electrical length of the two dipole elements. However, due to space constraints within the controller casing, a short dipole is preferred of total length L of about 65 mm compared to an optimum length of about 157 mm based on a centre frequency of 915 MHz.

Driving circuitry for the aerial may be of any suitable form, for example as shown in FIG. 6 in which a signal I′ from a transceiver (not shown) is fed via a HF filtering capacitor C to a wide band transformer 20 having a transformation ratio N, the secondary of the transformer being fed to a matching circuit 22 which is connected to both dipole elements 10. The matching circuit 22 is used to match the dipole impedance to the source impedance. In this embodiment, N equals 4 H is a 8.2 nH inductor and C is a 1.2 pF capacitor. The aerial is used for transmission and reception, with the signal flow being reversed.

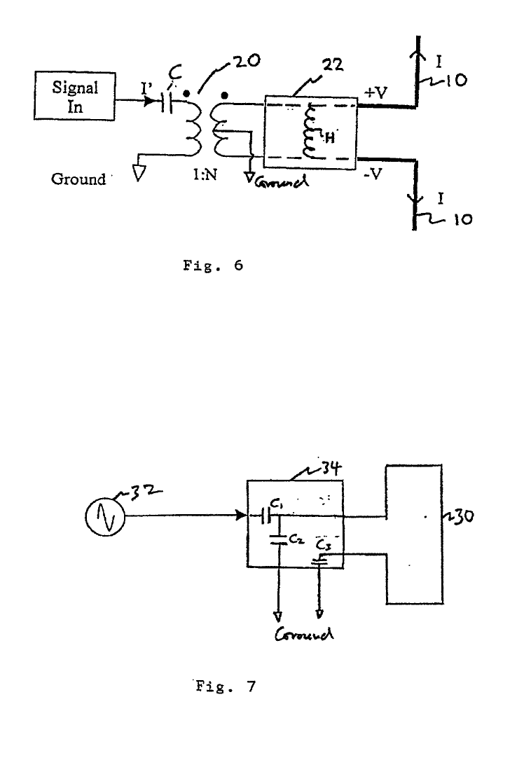

An aerial included in a base station of wireless game apparatus being a second embodiment of the invention is illustrated in FIGS. 4 and 5. The base station may be enclosed within the housing of a game console or may be separately provided, connected by a wired link. The aerial selected for the base station is a loop aerial as shown in FIG. 4. Although a circular loop is an ideal loop antenna since this maximises enclosed area for better efficiency while minimising resistive loss due to aerial length, such an aerial is not ideal for this application due to mechanical housing constraints. The length of the aerial is also preferably kept short to avoid resonance tuning problems for a long loop leading to impractical tuning capacitor size. Thus, a rectangular loop design 30 of about 84 mm in total length, as shown in FIG. 4 is selected. The loop includes four lugs 31, 32, 33 and 34 for securing the loop antenna 30 to a PCB 36 of the base station, as shown in FIG. 5. Lugs 32, 33 connect the aerial to the driving circuitry.

As can be seen from FIG. 5, the aerial 30 is mounted at the periphery of the PCB 36 at one edge which is arranged, in use, to face the game player holding the game controller. The aerial is formed from bent metal and attached to the printed circuit board to aid simple and inexpensive manufacturing and for aesthetic purposes is contained within the casing of the base station or console.

Any suitable driving circuit may be used, for example as shown in FIG. 7 where the impedance of the loop aerial 30 is matched to signal source 32 via a matching circuit 34 of three capacitors C1-C3 to provide a resonance frequency for the loop antenna at a centre frequency between 902 and 928 MHz. In this embodiment C1=2.2 pF, C2=3 pF and C3=0.5 pF.

The embodiment described is not to be construed as limitative. In particular, a loop antenna is also known to retain gain near the human body and may provide a ground enhancement effect when held close to the game player and thus an aerial, such as the rectangular loop aerial described with reference to FIGS. 4 and 5, is suitable for use with the game controller as well as the base station.

1. A wireless electronic game controller operable by a game player and arranged to communicate with a game console over a wireless link via an aerial and wherein the aerial is a loop aerial or a dipole aerial.

2. Apparatus as claimed in claim 1 wherein the aerial is a short dipole.

3. Apparatus as claimed in claim 1 wherein the aerial is disposed within a casing of the controller.

4. Apparatus as claimed in claim 1 wherein the aerial is disposed at a peripheral portion of the controller.

5. Apparatus as claimed in claim 1 wherein the aerial is disposed at the region of the controller arranged to be distant from the game player's body, in use.

6. A game controller as claimed in claim 1 wherein the aerial is formed from at least one piece of bent metal.

7. A game controller as claimed in claim 1 wherein the aerial is connected to a PCB assembly of the game controller.

8. A wireless electronic game base station connected to or forming part of a game console and arranged to communicate with the game controller over a wireless link via an aerial and wherein the aerial is a loop aerial.

9. A base station as claimed in claim 8 wherein the aerial is arranged to be disposed within a casing of the base station or console.

10. A base station as claimed in claim 8 wherein the aerial is disposed at a peripheral portion of the base station or console.

11. A base station as claimed in claim 8 wherein the aerial is disposed at the region of the base station or console arranged to face a game player, in use.

12. A base station as claimed in claims 8 wherein the aerial is formed from a piece of bent metal.

13. A base station as claimed in claim 8 wherein the aerial is connected to a PCB assembly of the base station.

14. Game playing apparatus comprising a game controller arranged to be held by a game player and a base station connected to or forming part of a game console, the controller and base station communicating over a wireless link and wherein the base station is provided with a loop aerial and the game controller is provided with either a dipole aerial or a loop aerial.
